(19) United States
(12) Patent Application Publication
(10) Pub. No.: US 2025/0140220 A1
(43) Pub. Date: May 1, 2025

(54) FINGERBOARD FOR MUSICAL INSTRUMENT

(71) Applicant: Marcodi Musical Products, LLC, Hydes, MD (US)

(72) Inventors: Timothy E. Meeks, Hydes, MD (US); Connor J. Meeks, Perry Hall, MD (US)

(73) Assignee: Marcodi Musical Products, LLC, Hydes, MD (US)

(21) Appl. No.: 18/888,540

(22) Filed: Sep. 18, 2024

Related U.S. Application Data
(60) Provisional application No. 63/593,117, filed on Oct. 25, 2023.

(51) Int. Cl. G10D 3/06; G10D 1/14; G10D 3/04; G10D 3/22; G10H 3/18

(52) U.S. Cl. CPC G10D 3/06; G10D 1/14; G10D 3/04; G10D 3/22; G10H 3/181; G10H 3/186; G10H 2220/461

(57) ABSTRACT

A musical instrument includes a substrate, a transparent fingerboard overlaying the substrate, and a support structure attached to the substrate and configured to support strings in tension above the transparent fingerboard. A pattern of position markers is located between the substrate and the transparent fingerboard and visible through the glass fingerboard. Optionally, the strings are electrically conductive, and one or more electrically conductive frets are located between the nut and the bridge and overlay the substrate perpendicular to the string. An electrical circuit, including the one or more electrically conductive frets, provides a first voltage when a string contacts a fret and a second voltage when the string does not contact a fret. A pre-amplifier circuit amplifies a vibration signal from a string vibration pickup in response to the first voltage and mutes the vibration signal in response to the second voltage.

### BACKGROUND

Some stringed instruments, such as a conventional guitar, use a fretboard. A note is played by pressing a vibrating string against a fret. The action of pressing the string against a fret may be used to incite the vibration. For example, a “hammer-on” is a playing technique performed on a stringed instrument by quickly bringing a fretting-hand finger down on to the fingerboard behind a fret, causing a note to sound. To aid in identifying positions on a fretboard, inlaid markers may be used between the frets. Other musical instruments, such as a violin or cello, use a fretless finger board. A note is played by vibrating a string pressed against the fingerboard. A fretless finger board is subject to wear and may be made of a hardwood such as ebony. To aid in identifying positions on a fingerboard, lines may be marked on top of the fingerboard to indicate where frets would be positioned. In general, a wooden fretless fingerboard tends to produce quieter, less sustained notes than a fretted fingerboard

A Harpejji®, produced by Marcodi Musical Products, LLC., is an electric stringed instrument with a fretboard, for which the primary method for making notes is to use a “hammer-on’, where a string is sharply pressed against a fret. A Harpejji® utilizes electronic muting technology. The electronic muting system senses whenever a string is in contact with any fret. All frets are electrically grounded. When a string is being fretted, it switches on the pickup sensor for that string only. This enables a player to amplify the strings they are playing while not amplifying the other strings. The Harpejji® also uses a note position marking system that capitalizes on the familiarity of white and black notes on a piano. Each note on a Harpejji® has a note marker under the string. In addition to their use in electronic muting, the frets reduce wear on the fretboard. In particular, the frets reduce wear on note position markers on the fretboard.

Fretless stringed instruments have a special unique sound and allow greater control of pitch and vibrato. While eliminating frets has these advantages, it also presents a number of problems. Firstly, wooden fretless fingerboards tend to produce quieter, less-sustained notes than a fretted fingerboard. Secondly, electronic muting is difficult without electrically conducting frets. Thirdly, the frets lessen the degree to which the strings scratch the fingerboard and any note position markers thereon.

### BRIEF DESCRIPTION OF THE DRAWINGS

The accompanying drawings provide visual representations which will be used to describe various representative embodiments more fully and can be used by those skilled in the art to understand better the representative embodiments disclosed and their inherent advantages. In these drawings, like reference numerals identify corresponding or analogous elements.

FIG. 1 is a drawing of a musical instrument, in accordance with various representative embodiments.

FIG. 2 is a side view of the musical instrument shown in FIG. 1, in accordance with various representative embodiments.

FIG. 3 is a further drawing of a musical instrument, in accordance with various representative embodiments.

FIG. 4 is a side view of the musical instrument shown in FIG. 3, in accordance with various representative embodiments.

FIG. 5 is a diagrammatic side view of a musical instrument, in accordance with various representative embodiments.

FIG. 6 is a further diagrammatic side view of a musical instrument, in accordance with various representative embodiments.

FIG. 7 is an expanded view of a musical instrument, in accordance with various representative embodiments.

FIG. 8 is a flow chart of a method of electronic muting in a musical instrument, in accordance with various representative embodiments.

FIG. 9 is a top view of a musical instrument, in accordance with various representative embodiments.

FIG. 10-13 are perspective views of a musical instrument, in accordance with various representative embodiments.

### DETAILED DESCRIPTION

The various apparatus and devices described herein provide an improved fingerboard for a stringed musical instrument.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

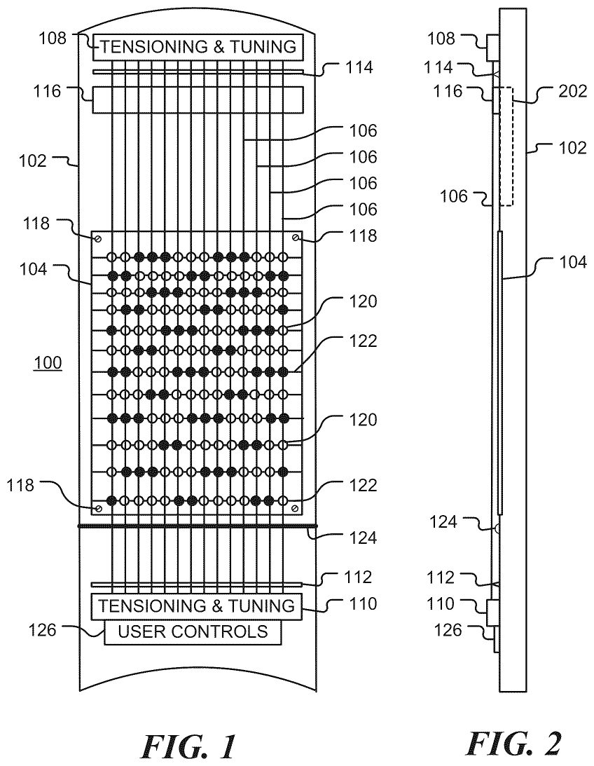

FIG. 1 is a drawing of a musical instrument, in accordance with various representative embodiments. Referring to FIG. 1, musical instrument 100 includes body 102 that provides a substrate for fingerboard 104. A plurality of strings 106 are stretched across fingerboard 104. Any number of strings may be used. Strings 106 are held in tension by tensioning assemblies 108 and 110. Either assembly 108 or assembly 110, or both assemblies 108 and 110, allow a user to adjust the tension in each string to allow the instrument to be tuned. A tensioning assembly may include elements that are commonly used to adjust tension in other stringed musical instruments, such as pianos, guitars, violins etc. For example, the tension may be increased by winding the string onto a spindle (such as a piano pin or peg) or by linearly adjusting the position of one end of the string (using a screw for example). A stringed musical instrument, such as musical instrument 100, includes a support structure, such as nut 112 and bridge 114, that supports strings 106 in tension over the body of the instrument.

Vibration of strings 106 is sensed by a plurality of vibration pickups 116. These may be magnetic pickups, as found in electric guitars for example, piezo-electric pickups, as used to amplify some acoustic guitars, optical pickups or other pickups that produce a signal in response to vibration of one or more strings. The use of piezo-electric or optical pickups allows non-ferrous strings (such as nylon strings) to be used.

The signals from the plurality of pickups 116 may be passed through signal conditioning circuits, amplified, and used to drive one or more loudspeakers to produce sound.

In accordance with an embodiment of the present disclosure, fingerboard 104 is transparent. For example, fingerboard 104 may be made of glass or a glass-like material overlaying substrate 102. Thus, the underside of fingerboard 104 overlies the upper surface of substrate 102. Glass is denser than wood and so enables louder, more-sustained notes to be played. In addition, glass is scratch resistant and can have a very smooth surface. These properties are shared by various other transparent materials. Various types of glass may be used such as tempered glass and borosilicate glass. In one embodiment, borosilicate float glass is used. Various fasteners, such as screws 118, may be used to couple the fingerboard to the substrate.

In accordance with some embodiments of the present invention, musical instrument 100 is marked with a plurality of position markers. In the embodiment shown, position markers 120 indicate positions where strings may be pressed to play a note in a scale, while position markers 122 are lines indicating where a fret would be placed on a fretted instrument. A note marker 120 may be a symbol, shape, color, light or other identifying feature. When a whole tone tuning system is used a “piano-like” marking scheme can be employed. On a piano, the white keys produce the notes A through G, which are within the C major scale, while the black keys produce the notes C #, D #, F #, G #and A #, which are outside of the C major scale. The black keys appear in alternating clusters of two and three. The visual clustering of common markers can assist players of the instrument 100 who are familiar with piano, organ or other keyboard instruments. It will be apparent to those of ordinary skill in the art that markers other than circles may be used and colors other than black and white may be used.

In accordance with the present disclosure, the pattern of position markers is situated between substrate 102 and fingerboard 104 and is visible through the fingerboard when the fingerboard is transparent. The pattern of position markers may be situated on the upper surface of the substrate or the lower surface of the fingerboard. For example, the position markers may be vinyl markers adhered to the underside of a glass fingerboard or to the upper surface of the substrate. Alternatively, the position markers may be painted or silkscreened onto the underside of the glass of the upper surface of the substrate. Other types of markers may be used. The position markers are protected from wear by the glass fingerboard. In the embodiment shown in FIG. 1, a region of the fingerboard provides a fretless playing area. In this region, the position markers may include fret position markers 122, such as lines perpendicular to the strings to indicate where frets would have been situated. The lines indicate where to depress a string to produce a particular note.

In an embodiment of the disclosure, strings 106 are electrically conductive and musical instrument 100 includes one or more electrically conductive frets located between the support structure provided by nut 112 and bridge 114 and overlaying the substrate 102 in a direction perpendicular to the strings. The embodiment shown in FIG. 1 has a single fret 124. Fret 124 may be configured to enable a string to be pressed against the fret to play a note. Alternatively, fret 124 may be an electrically conductive bar that is not designed for playing a note. Herein, element 124 will be referred as to a “fret,” whether or not it is configured for playing a note. The electrically conductive strings enable the musical instrument to include electronic muting. For example, the musical instrument may house an electrical circuit, including the one or more electrically conductive frets, configured to provide a first voltage when the electrical circuit is completed by a string of the plurality of string contacting a fret of the one or more electrically conductive frets and to provide a second voltage when the string does not contact a fret of the one or more electrically conductive frets. Vibration pickups 116 are located between bridge 114 and the closest electrically conductive fret to the bridge (124 in FIG. 1). Each vibration pickup is configured to generate a vibration signal in response to vibration of the string. A pre-amplifier circuit is configured to amplify the vibration signal when the first voltage is present and to mute the vibration signal when the second voltage is present.

Optionally, user controls 126 are provided to enable a user to adjust characteristics of an electrical circuit that filters and amplifies signals from vibration pickups 116. In FIG. 1, user controls 126 are located on the top side of the instrument, close to the user. User controls may be placed in other locations—such as at the side of the instrument. In one embodiment, user controls 126 are located on the left side of the instrument, close to the user.

FIG. 2 is a side view of the musical instrument shown in FIG. 1, in accordance with various representative embodiments. Nut 112 and bridge 114 are attached to substrate 102 and provide a support structure configured to support strings 106 in tension in a first direction above fingerboard 104. String tension is maintained and adjusted using tensioners 108 and 110. Single fret 122 is located between strings 106 and substrate 102 and does not contact a string until the string is pressed against fingerboard 104. Fingerboard 104 is mounted on substrate 102. Optionally, fingerboard 104 is partially or fully recessed in substrate 102.

The body, 102, of the musical instrument may contain a cavity, 202, that can be used to house ancillary components, such as one or more electronic circuits for electronic muting or sound modification.

The musical instrument may have two distinct playing regions with a transparent fingerboard overlaying a first region of the substrate and one or more electrically conductive frets overlaying a second region of the substrate. The first region is located between the second region and the bridge.

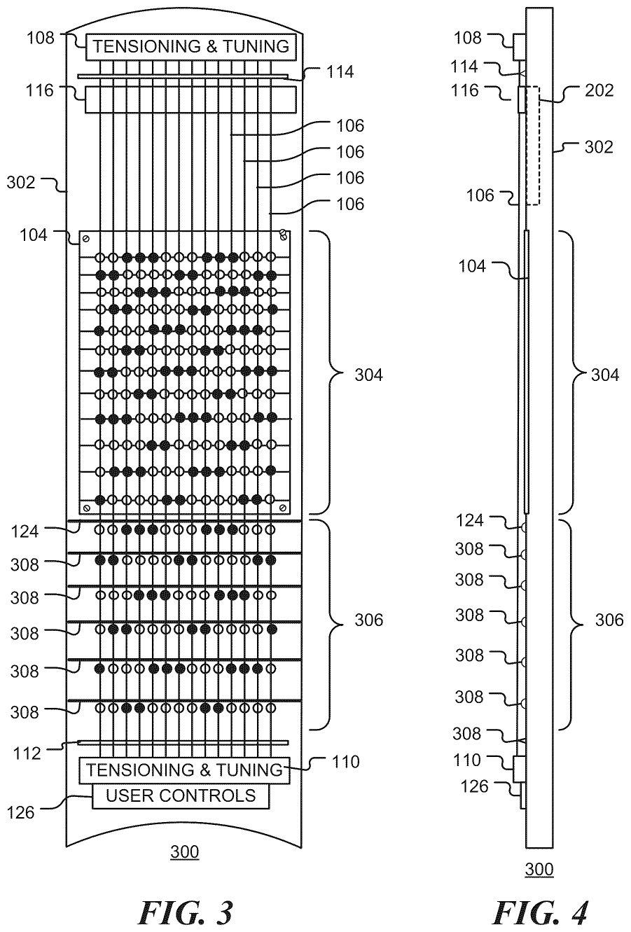

FIG. 3 is a drawing of a musical instrument, in accordance with various representative embodiments. As in the embodiment shown in FIG. 1, musical instrument 300 includes body 302, which provides a substrate for fingerboard 104, and a plurality of strings 106 are stretched across fingerboard 104. The fingerboard is located in first region, 304 of musical instrument 300, while a fretboard occupies second region, 306. Fretboard 306 is configured as a conventional Harpejji®, and includes electrically conductive frets 308 attached to body 302 and positioned perpendicular to strings 106. Region 306 may also contain note position markers, such as indicated by the white and block circles in region 306. Musical instrument 300 can be played by pressing strings 106 against frets in fretboard region 306, or by pressing strings 106 against fingerboard 104 in region 304, providing a range of different sounds. For example, note “slides” may be played in fretless fingerboard region 304.

FIG. 4 is a side view of the musical instrument shown in FIG. 3, in accordance with various representative embodiments. The side view shows raised frets 308 attached to body 302 in region 306.

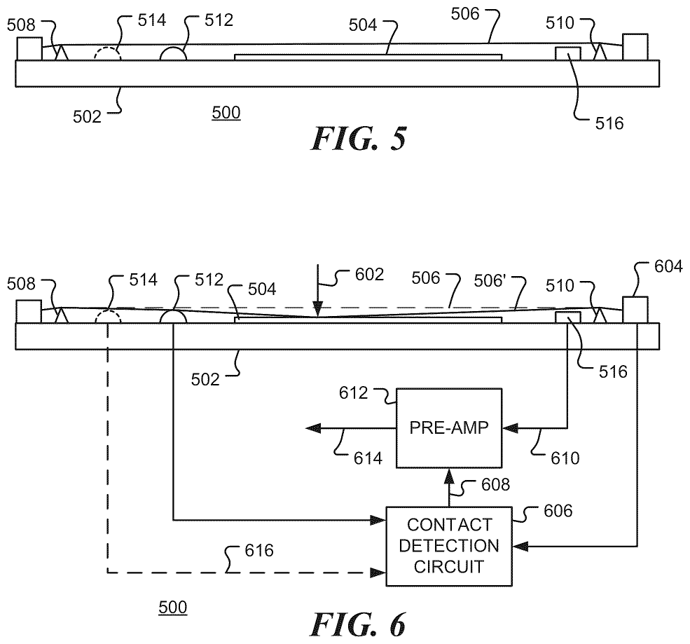

FIG. 5 is a diagrammatic side view of a musical instrument 500, in accordance with various representative embodiments. Dimensions have been altered and some components are not shown so as to aid the description. Musical instrument 500 includes substrate or body 502, fingerboard 504 and string 506. Fingerboard 504 overlays substrate 502. Nut 508 and bridge 510, attached to substrate 502, provide a support structure configured to support strings in tension above fingerboard 504. Substrate 502 also supports first fret 512 and, optionally, additional frets 514. Vibration pickup or transducer 516 produces an electrical signal in response to vibration of string 506.

FIG. 6 is a further side view of a musical instrument 500, in accordance with various representative embodiments. FIG. 6 shows deflected string 506′. The deflection is caused by pressing the string against fingerboard 504 at the position indicated by arrow 602. Deflected string 506′ makes electrical contact with first fret 512 and, since the string is electrically conductive, completes an electrical circuit between first fret 512 and tensioning assembly 604. The contact is detected by contact detection circuit 606 and provides an indication 608 that the string has been played. Vibration pickup or transducer 516 produces an electrical signal in connection 610 in response to vibration of deflected string 506′. The signal is fed to pre-amplifier 612 that, in turn produces an output signal at 614. The output signal can be amplified further and used to drive a loudspeaker. The output signal may be muted based on indication 608. This may be done, for example, by disabling pre-amplifier 612 or by disconnecting the output signal using a switch.

It can be seen from FIG. 6, that deflected string 506′ makes electrical contact with first fret 512 no matter where position 602 is located on fingerboard 504. Thus, a single fret is sufficient to enable electronic muting. Optionally, when additional frets 514 are used, they may also be connected to contact detection circuit 606 via connection 616.

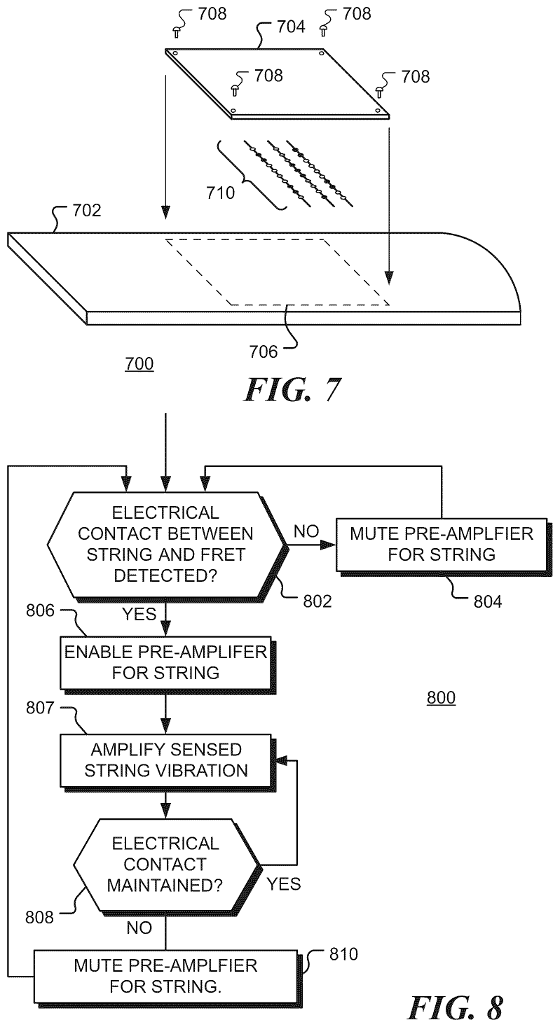

FIG. 7 is an expanded view of a musical instrument, in accordance with various representative embodiments. Musical instrument 700 includes body 702 that provides a substrate to which transparent fingerboard 704 (such as a glass fingerboard) is to be attached. In the example shown, fingerboard 704 is to be attached to region 706 using screws or other fixings 708. Position markers 710 are to be located between the upper surface for substrate 702 and the lower surface of fingerboard 704. In some embodiments, the position markers are made from a sheet material such as metal, paper or plastic, for example. For example, the position markers may be vinyl markers. The position markers may be adhered to the upper surface for substrate 702 or the lower surface of fingerboard 704. In a further embodiment, position markers 710 are painted or inked onto the upper surface for substrate 702 or the lower surface of fingerboard 704. This may be done in a variety of ways including, but not limited to, printing, stenciling and screening.

When the instrument is assembled, position markers 710 are protected from wear by fingerboard 704. However, the position markers are visible to a player due to the transparency of the fingerboard.

FIG. 8 is a flow chart of a method 800 of electronic muting in a musical instrument, in accordance with various representative embodiments of the disclosure. When there is no electrical contact between an electrically conductive string of a musical instrument and an electrically conductive fret of the musical instrument, as depicted by the negative branch from decision block 802, the vibration signal from a vibration pickup for the string is muted at block 804. When electrical contact between the string and electrically conductive fret is detected, as depicted by the positive branch from decision block 802, the pre-amplifier is enabled at block 806 and vibration signal from the vibration pickup is amplified at block 807. The contact may be formed when the string is pressed again a fretless region of a fingerboard of the musical instrument at a location between the electrically conductive fret and the vibration pickup. While the electrical contact is maintained, as depicted by the positive branch from decision block 808, amplification of sensed vibration signal from the pickup continues. When the electrical contact is broken, as depicted by the negative branch from decision block 808, the vibration signal is muted at block 810. The muting may be achieved by gradually reducing the amplifier gain to zero over a short time period, or by muting the signal after a short pause, for example. Flow then returns to block 802.

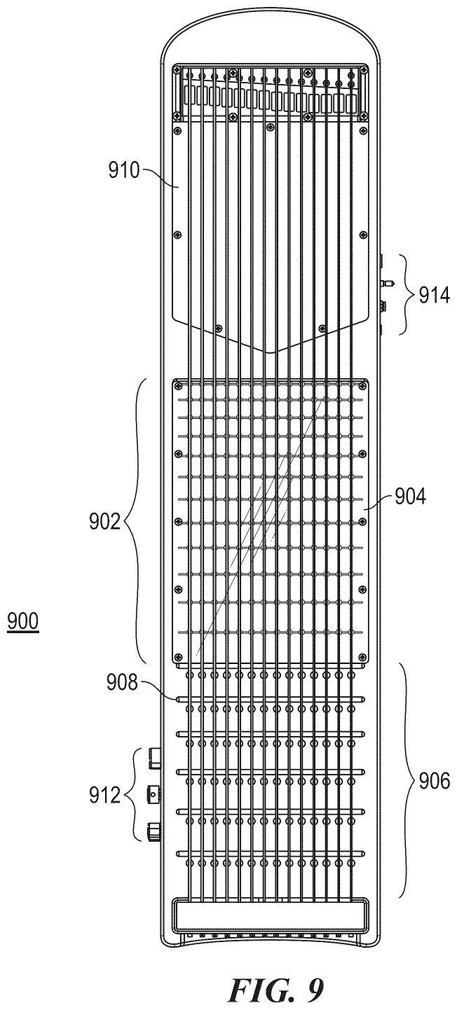

FIG. 9 is a top view of a musical instrument 900, in accordance with various representative embodiments. Region 902 of the instrument is configured for fretless playing and includes transparent fingerboard 904. Region 906 of the instrument is configured for fretted playing and includes frets such as fret 908. Cover 910 covers a cavity in the instrument that may be used to house electronic circuits. Operation of the circuits may be controlled by user controls 912. Connectors 914 enable an electrical output signal to be coupled to an external amplifier and loudspeaker.

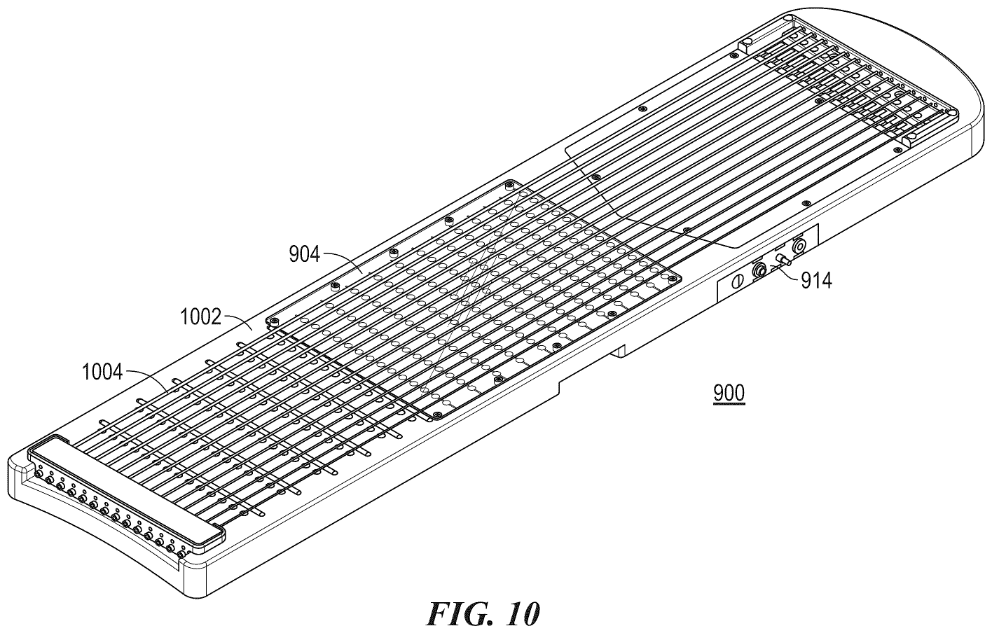

FIG. 10 is a perspective view of musical instrument 900, in accordance with various representative embodiments. Transparent fingerboard 904 overlays substrate 1002 and allows strings 1004 to be played without frets. Connectors 914 enable the electrical output signal to be coupled to an external amplifier and loudspeaker.

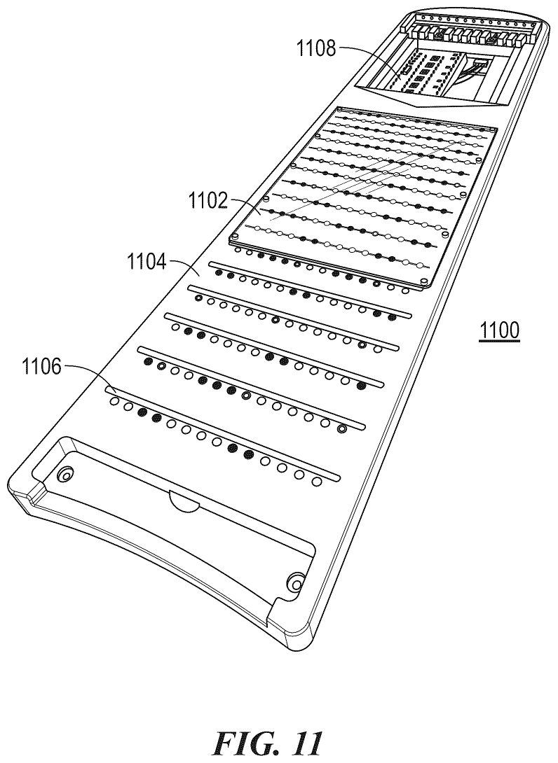

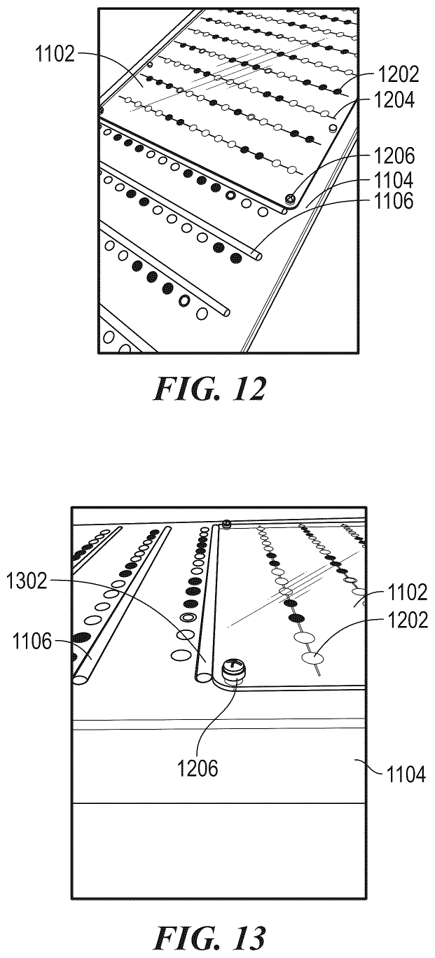

FIGS. 11-13 show further perspective views of a partially assembled musical instrument, in accordance with various representative embodiments. FIG. 11 shows musical instrument 1100 with glass fingerboard 1102 overlaying a first region of the instrument body 1104. A second region of the instrument body supports frets 1106. A cavity in body 1104 is used to house electronic circuit 1108. FIG. 12 shows more detail of the musical instrument. Note position markers, such as 1202, and fret position markers such as line 1204, are situated between body 1104 and glass fingerboard 1102. Glass fingerboard 1102 is attached to instrument body 1104 using screws 1206. A second region of the instrument body supports frets 1106.

FIG. 13 shows more detail of the musical instrument 1100. Note position marker 1202 is situated between body 1104 and glass fingerboard 1102. Glass fingerboard 1102 is attached to instrument body 1104 using screws 1206. Fret 1302 is the closest fret to the fingerboard and is used to detect when a string is pressed against fingerboard 1102. Frets 1106 and 1302 may be used to fret a string to produce a note.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added. or operations can be deleted without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed:

1. A musical instrument comprising:
a substrate;
a transparent fingerboard overlaying the substrate;
a support structure attached to the substrate and configured to support a plurality of strings in tension above the transparent fingerboard; and
a pattern of position markers between the substrate and the transparent fingerboard and visible through the transparent fingerboard.

2. The musical instrument of claim 1, where the transparent fingerboard is glass.

3. The musical instrument of claim 1, where the transparent fingerboard is borosilicate glass.

4. The musical instrument of claim 1, where strings of the plurality of strings are electrically conductive, the musical instrument further comprising:
one or more electrically conductive frets located between a nut and a bridge of the support structure configured to support the plurality of strings in tension in a first direction and the one or more electrically conductive frets overlaying the substrate in a second direction, perpendicular to the first direction;
an electrical circuit, including the one or more electrically conductive frets, configured to provide:
a first voltage when the electrical circuit is completed by a string of the plurality of string contacting a fret of the one or more electrically conductive frets; and
a second voltage when the string does not contact a fret of the one or more electrically conductive frets;
a vibration pickup located between the bridge and the one or more electrically conductive frets and configured to generate a vibration signal in response to vibration of the string; and
a pre-amplifier circuit configured to amplify the vibration signal in response to the first voltage and to mute the vibration signal in response to the second voltage.

5. The musical instrument of claim 4, where the pattern of position markers includes a plurality of position markers between the vibration pickup and a fret of one or more electrically conductive frets located closest to the vibration pickup.

6. The musical instrument of claim 4, where the one or more electrically conductive frets consists of a single electrically conductive fret and the transparent fingerboard is situated between the fret and the vibration pickup.

7. The musical instrument of claim 4, where the one or more electrically conductive frets overlay a first region of the substrate, and the transparent fingerboard overlays a second region of the substrate between the first region and the bridge.

8. The musical instrument of claim 1, further comprising a plurality of fasteners that couple the transparent fingerboard to the substrate.

9. The musical instrument of claim 1, where an underside of the transparent fingerboard overlies an upper surface of the substrate and where the pattern of position markers is applied to the upper surface of the substrate.

10. The musical instrument of claim 1, where an underside of the transparent fingerboard overlies an upper surface of the substrate and where the pattern of position markers is applied to the lower surface of the transparent fingerboard.

11. A method of electronic muting comprising:
detecting an electrical contact between an electrically conductive string of a musical instrument and an electrically conductive fret of the musical instrument when the string is pressed against a fretless region of a fingerboard of the musical instrument at a location between the electrically conductive fret and a vibration pickup responsive to vibration of the string;
amplifying a vibration signal from the vibration pickup when the electrical contact is detected; and
muting the vibration signal from the vibration pickup when electrical contact is not detected.

12. A method of generating a musical note, comprising:
detecting an electrical contact between an electrically conductive string of a musical instrument and an electrically conductive fret of the musical instrument when the string is pressed against a fretless region of a fingerboard of the musical instrument at a location between the electrically conductive fret and a vibration pickup responsive to vibration of the string; and
sensing vibration of the electrically conductive string by the vibration pickup to produce a vibration signal;
amplifying the vibration signal when the electrical contact is detected.

13. The method of claim 12, further comprising muting the vibration signal from the vibration pickup when electrical contact is not detected.

14. The method of claim 12, further comprising:
detecting an electrical contact between an electrically conductive string of the musical instrument when the string is pressed against an electrically conductive fret in a fretted region of the musical instrument;
sensing vibration of the electrically conductive string by the vibration pickup to produce a vibration signal; and
amplifying the vibration signal when the electrical contact is detected.
